(19) United States
(12) Patent Application Publication
(10) Pub. No.: US 2001/0007958 A1
(43) Pub. Date: Jul. 12, 2001

(54) Data driven computer, and data driven computer system

(75) Inventor: Ken Mabuchi, Kawasaki-shi (JP)

Correspondence Address: OBLON, SPIVAK, McCLELLAND,, MAIER & NEUSTADT, P.C., Fourth Floor, 1755 Jefferson Davis Highway, Arlington, VA, 22202, US

(73) Assignee: KABUSHIKI KAISHA TOSHIBA, Kawasaki-shi (JP)

(21) Appl. No.: 09/750,763

(22) Filed: Jan. 2, 2001

(30) Foreign Application Priority Data
Jan. 4, 2000 (JP) P2000-98

(51) Int. Cl. G05B 19/18; G06F 15/16

(52) U.S. Cl. 700/2; 712/209; 712/203

(57) ABSTRACT

In the data driven computer system (FIG. 4, FIG. 7), data are transferred between data driven computers (1, 11, 12, 21, 22, 24, 25, . . . , and n), with instruction code (code) and identification numbers to identify data for arithmetic operation. Calculation results obtained by arithmetic units (111, 121, 21n, 22n, 24n, 25n, . . . , and nn) are stored in a data field (data). In parallel, an instruction rewriting units (3, 115, 125, 134, 211, 221, 241, 251, . . . , and nl) calculates an instruction code to be used in a following process and then rewrite a current instruction code with the calculated one without any execution of a microprocessor (14) or other controller. The result of the arithmetic operation is transferred to a peripheral device (16) or the microprocessor (14) through the data driven computer (13, 23).

### CROSS-REFERENCE TO RELATED APPLICATION

This application claims benefit of priority under 35 USC § 119 to Japanese Patent Application No. 2000-98, filed on Jan. 4, 2000, the entire contents of which are incorporated herein by reference herein.

### BACKGROUND OF THE INVENTION

1. Field of the Invention

The present invention relates to a data driven computer and a data driven computer system in which data with instruction codes and identification numbers are transferred among arithmetic units and arithmetic operation results are reflected to the data.

2. Description of the Related Art

In a Neumann type super scalar computer has a highly complicated configuration in order to control pipeline processes that are necessary to execute out-of order such as a data hazard check, a resource hazard check, and so on. Accordingly, a control circuit to control the above various pipeline processes has also a highly complicated configuration. Further, the control circuit to control a dynamical scheduling for instruction issues and to increase the degree of the parallel processing for arithmetic operations that are a feature of the super scalar computer has also highly complicated. Thereby, it takes many times to perform the design and the verification of the configuration of the super scalar computer.

Thus, the conventional computers have the highly complicated configurations to control the dynamical instruction issue and to increase the degree of the parallel processing for the arithmetic operations. These drawbacks introduce the difficulty to develop and verify a computer and a computer system.

### SUMMARY OF THE INVENTION

Accordingly, an object of the present invention is, with due consideration to the drawbacks of the conventional technique, to provide a data driven computer and a data driven computer system having a highly parallel processing and a highly execution performance without introducing any complicated configuration. It is thereby possible to easily develop and verify the data driven computer and the data driven computer system.

In accordance with a preferred embodiment of the present invention, a data driven computer comprises a storing unit, a content address memory (CAM), an arithmetic unit, and an instruction rewriting unit. In this computer, the storing unit inputs and temporarily stores an information group made up of an instruction code to determine operation of the computer, target data, including data to be used in arithmetic operation, as a target in the arithmetic operation indicated by the instruction code, and an identification code to identify data to be calculated with the target data. The CAM is connected with the storing unit. The CAM stores one or more the information groups in which the information group is searched by using the identification number as a searching key, and the information group is red and outputted when the information group designated by the searching key is stored, and the information group is stored into the CAM when the information group designated by the searching key is not stored in the CAM. The arithmetic unit inputs the instruction code stored in the storing unit or in the CAM, the data stored in the storing unit, and the data stored in the CAM, and then performs arithmetic operation of these data. The instruction rewriting unit inputs the instruction codes and the identification codes transferred from both the storing unit and the CAM, calculates an information group including the arithmetic result from the arithmetic unit to be executed in a following processing, in parallel to the arithmetic operation of the arithmetic unit, and rewrites the inputted information groups into the calculated information group.

In accordance with another preferred embodiment of the present invention, a data driven computer comprises a storing unit, an arithmetic unit, and an instruction rewriting unit. The storing unit inputs and temporarily stores an information group made up of an instruction code to determine operation of the computer, target data, including data to be used in arithmetic operation, as a target in the arithmetic operation indicated by the instruction code, and an identification code to identify data to be calculated with the target data. The arithmetic unit inputs the instruction code and data in the information group stored in the storing unit, and then performs arithmetic operation of the data. The instruction rewriting unit inputs the instruction code and the identification code transferred from the storing unit, calculates an information group to be executed in a following processing, in parallel to the arithmetic operation of the arithmetic unit, and rewrites the inputted information group into the calculated information group.

In accordance with another preferred embodiment of the present invention, a data driven computer system comprises a plurality of the data driven computers of the present invention described above, and a switch section connected to the data driven computers. The switch section inputs the information group transferred from the data driven computers, and selects the data driven computer based on the instruction code in the information group transferred from the data driven computers, and outputs the information group to the selected data driven computer.

In the data driven computer system described above, the switching section is connected to outer computer system, and also connected to a peripheral device through the data driven computer. The switching section inputs the information group from and outputs the information group to the outer computer system, and outputs the information group to the peripheral device.

### BRIEF DESCRIPTION OF THE DRAWINGS

These and other objects, features, aspects and advantages of the present invention will become more apparent from the following detailed description of the present invention when taken in conjunction with the accompanying drawings, in which:

FIG. 1 is a block diagram showing a configuration of a data driven computer according to the first embodiment of the present invention;

FIG. 2 is a block diagram showing another configuration of the data driven computer according to the first embodiment of the present invention;

FIG. 3 is a block diagram showing another configuration of the data driven computer according to the first embodiment of the present invention;

FIG. 4 is a block diagram showing a configuration of a data driven computer system including the data driven computer;

FIG. 5 is a flow chart showing a processing of an instruction rewriting unit in the data driven computer;

FIG. 6 is a diagram showing the analysis for the calculation tree of an equation 1; and

FIG. 7 is a block diagram showing a configuration of another data driven computer system including the data driven computer according to another preferred embodiment of the present invention.

### DESCRIPTION OF THE PREFERRED EMBODIMENTS

Other features of this invention will become apparent through the following description of preferred embodiments which are given for illustration of the invention and are not intended to be limiting thereof.

First Embodiment

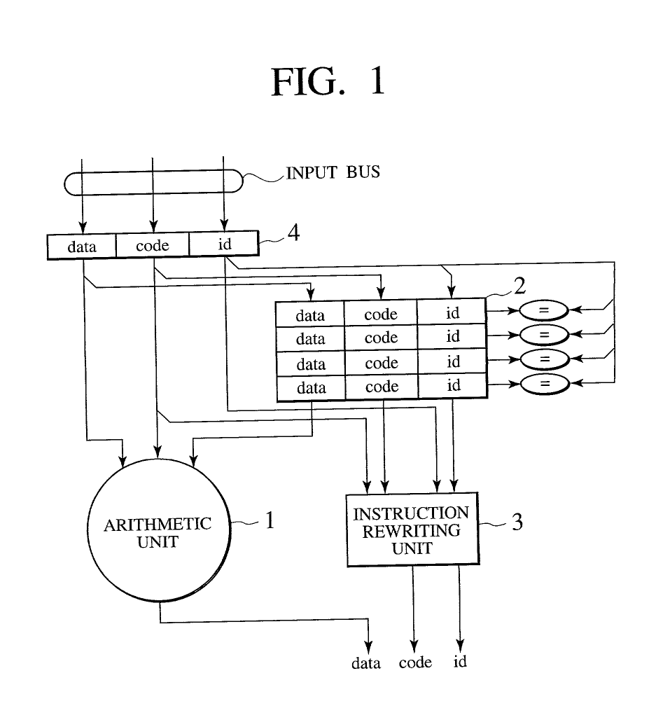

FIG. 1 is a block diagram showing a configuration of the data driven computer according to the first embodiment of the present invention. In FIG. 1, the data driven computer for performing the arithmetic operation of two operand data, which comprises an arithmetic unit 1, a content address memory (hereinafter referred to as “CAM”) 2 as an associative memory, an instruction rewriting unit 3, and an input instruction/data storing unit 4.

The arithmetic unit 1 performs a dedicated function, for example, elementary calculations (addition, subtraction, multiplication, and division), taking square roots, logical arithmetic operations, writing data to external units, and transferring return values to a microprocessor, and the like. The CAM 2 has one or more entries in which data, instruction codes, and identification numbers are stored, and also searches and reads the contents of data stored in the entries. The instruction rewriting unit 3 inputs the instruction code and the identification number, rewrites and sets the instruction code and the identification number that will be executed in the following arithmetic operation, and then outputs the rewritten them. The input instruction/data storing unit 4 stores temporarily data items, the instruction code, and identification number for the arithmetic operation.

Next, a description will be given of the operation of the data driven computer having the above configuration.

First, a group of data, an instruction code, and an identification number is transferred from a control device such as a microprocessor (not shown) through an input bus connected to the input instruction/data storing unit 4. The input instruction/data storing unit 4 stores temporarily the group of the data, the instruction code, and the identification number.

Next, the identification number stored in the input instruction/data storing unit 4 is compared with each of the identification number stored in the CAM 2. When both do not equal, namely when there are no same identification number in the CAM 2, the group of the data, the instruction code, and the identification number in the storing unit 4 is transferred and then stored into the CAM 2. The use of the group of them stored in the CAM 2 is waited until the same identification number is transferred and stored into the input instruction/data storing unit 4. On the other hand, when there is the same identification number, namely, the identification number in the storing unit 4 is the same as that of the CAM 2, the group of the data, the instruction code, and the identification number is red from the CAM 2, and both the data and the instruction code stored in the storing unit 4 and the data stored in the CAM 2 are transferred to the arithmetic unit 1. The instruction code and the identification code in each of the storing unit 4 and the CAM 2 are transferred to the instruction rewriting unit 3.

The arithmetic unit 1 performs an arithmetic operation such as elementary calculations (addition, subtraction, multiplication, and division) and the like and then outputs the operation result. On the other hand, the instruction rewriting unit 3 inputs two groups of the instruction code and the identification number from the storing unit 4 and the CAM 2, and generates both an instruction code and an identification number that will be executed in the following process and outputs the generated them with the data transferred as the operation result from the arithmetic unit 1. In the rewriting process in the instruction rewriting unit 3, one of the groups, each including both the instruction code and identification number, is eliminated.

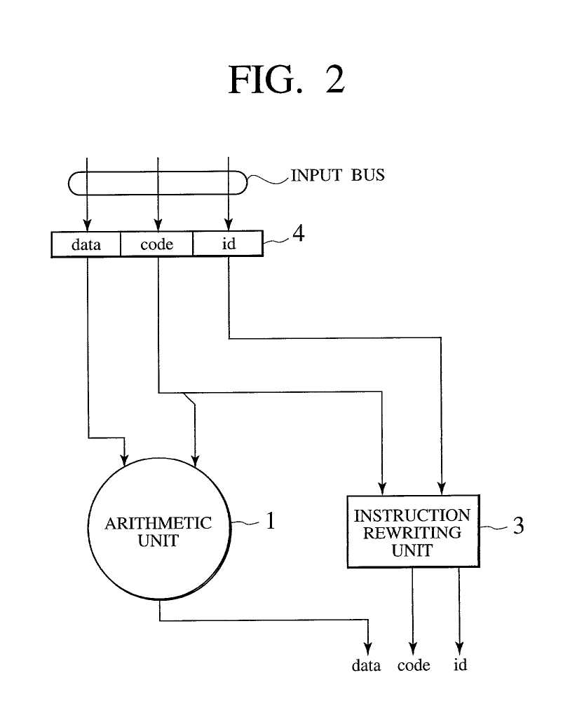

FIG. 2 is a block diagram showing another configuration of the data driven computer that processes one operand data.

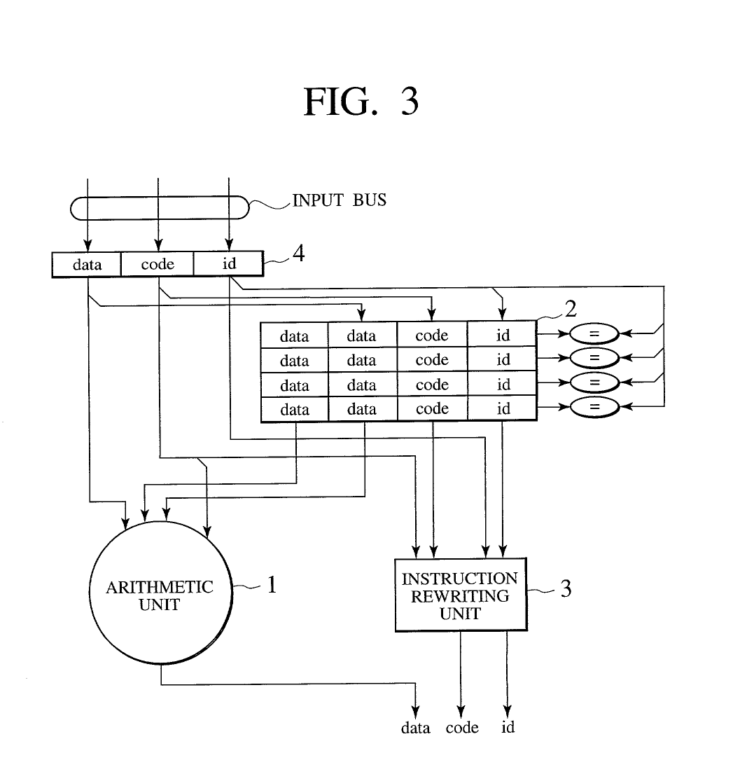

FIG. 3 is a block diagram showing another configuration of the data driven computer that processes three operand data.

The configuration shown in FIG. 2 has no CAM such as the CAM 2 in the configuration shown in FIG. 1 because there is no group of data to be waited in the configuration of FIG. 2. Other components of the configuration shown in FIG. 2 are the same as those of the configuration shown in FIG. 1.

On the other hand, in the configuration of the data driven computer of the three operand type shown in FIG. 3, one field of data is added in the CAM 2 when compared with the configuration shown in FIG. 1 and the arithmetic unit 1 is the unit of three inputs. Other components of the configuration shown in FIG. 3 are the same as those of the configuration shown in FIG. 1.

In the added field in the CAM 2, when both the identification numbers in the storing unit 4 and the CAM 2 are equal at the first input process, the data in the storing unit 4 is stored into the added data field in the CAM 2 having the same identification number without any arithmetic operation by the arithmetic unit 1. Then, when the identification numbers of the storing unit 4 and the CAM 2 are equal twice in the second input process, the arithmetic unit 1 performs the arithmetic operation by using the data stored in both the input instruction/data storing unit 4 and the CAM 2.

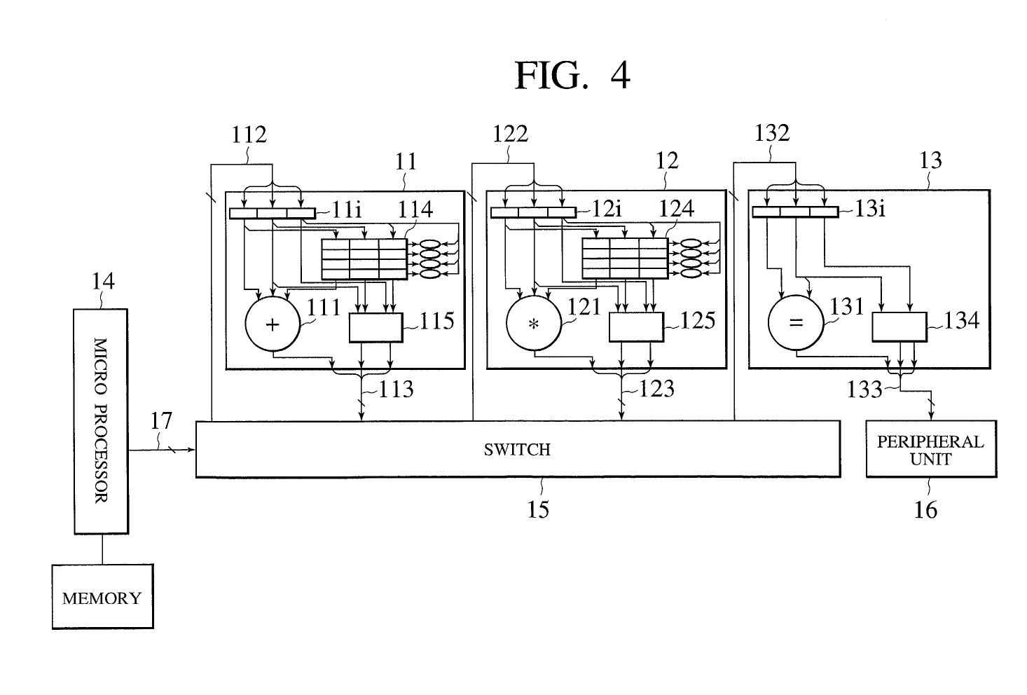

FIG. 4 is a block diagram showing a configuration of a data driven computer system including the data driven computers having the configuration described above.

The data driven computer system shown in FIG. 4 comprises the data driven computers 11, 12, 13, and 14, a switch section 15, and a peripheral unit 16.

Each of the data driven computers 11, 12, and 13 corresponds to the data driven computer shown in FIG. 1, but, the present invention is not limited by this configuration, for example, it is possible to use the data driven computer shown in FIG. 2 or FIG. 3.

In FIG. 4, the reference characters 11i, 12i, and 13i indicate input instruction/data storing units, each corresponds to the input instruction/data storing unit 4 shown in FIG. 1. Similarly, each of the reference numbers 111, 121, and 131 denotes an arithmetic unit that corresponds to the arithmetic unit 1 shown in FIG. 1, and each of the reference numbers 114 and 124 designates a CAM that corresponds to the CAM 2 shown in FIG. 1.

The microprocessor 14 is connected to the switch section 15 through the instruction/data bus 17, and supplies instructions and data to the switch section 15 through the instruction/data bus 17.

The memory connected to the microprocessor 14 shown in FIG. 4 stores a string of instruction/data as the results of a compiler (not shown) or a string of instruction/data obtained by executing a program by the microprocessor 14.

The data driven computer 11 (whose basic configuration is shown in FIG. 1) comprises the arithmetic unit 111 performing addition is connected to the switch section 15 through the bus 112 and the bus 113 in order to input the instruction/data through the bus 112 and to output instruction/data through the bus 113.

The data driven computer 12 (whose basic configuration is also shown in FIG. 1) comprises the arithmetic unit 121 performing multiplication is connected to the switch section 15 through the bus 122 and the bus 123 in order to input the instruction/data through the bus 122 and to output instruction/data through the bus 123.

The data driven computer 13 (whose basic configuration is also shown in FIG. 2) comprises the arithmetic unit 131 performing substitution arithmetic operation is connected to the switch section 15 through the bus 132 and the bus 133 in order to input the instruction/data through the bus 132 and to output instruction/data through the bus 133.

In the data driven computer system shown in FIG. 4, the microprocessor 14 supplies instruction/data to the computer system, and the operation results are transferred to the peripheral unit 16.

Each of the instruction rewriting units 115, 125, and 134 in the data driven computers 11, 12, and 13 is made according to the application field to which this computer system is applied, for example, it can be formed by using simple shift registers and comparators.

In the following explanation of the operation of the data driven computer system in this preferred embodiment, the instruction codes are firstly defined.

Because the data driven computer system comprises computers of three types, that perform addition, subtraction, and multiplication, respectively, the following instruction codes and the terminal code are defined:

00: terminal code

01: addition

10: multiplication

11: substitution

Next, the operation of the instruction rewriting unit will be explained.

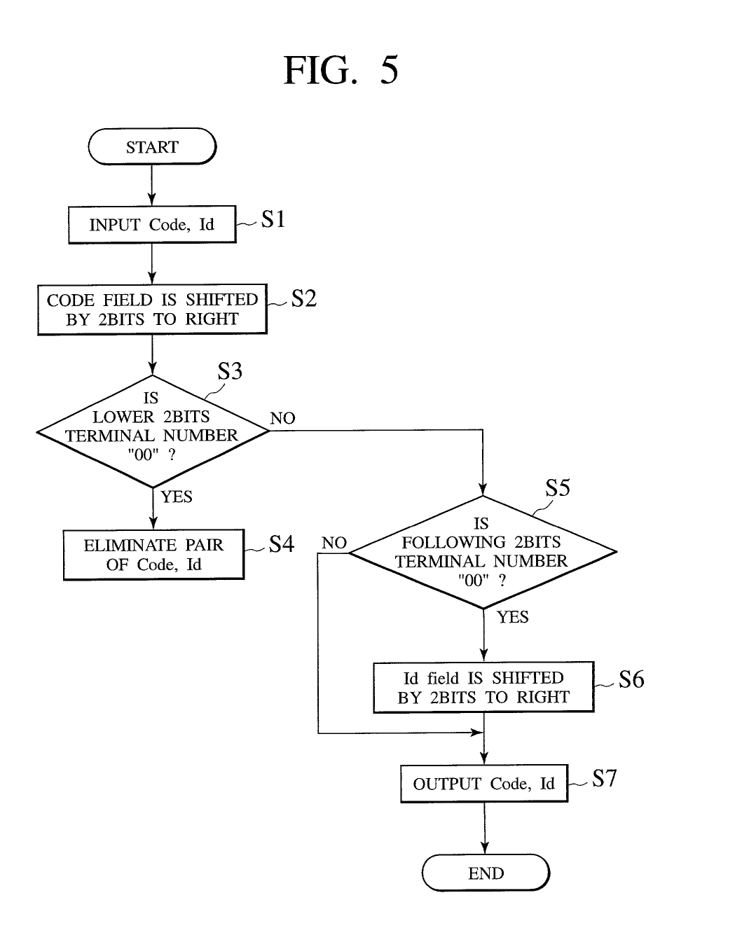

FIG. 5 is a flow chart showing the processing of the instruction rewriting unit in the data driven computer.

In the processing procedure shown in FIG. 5, the instruction rewriting unit 3 inputs an instruction code and identification number (Code, Id) (Step S1). A shift register in the instruction rewriting unit 3 shifts the value in the field of the instruction code by two bits (Step S2) and a comparator compares the lower two bits of the instruction code with the terminal code “00” (Step S3). When the lower two bits in the instruction code is equal to the terminal code “00”, the instruction rewriting unit 3 eliminates the pair of this instruction code and the identification number (Step S4). On the contrary, when both are not equal, the following two bits counted from the lower two bits are then compared with the terminal code “00”. When both are equal, the instruction rewriting unit 3 shifts the identification number by two bits toward the right direction (Step S6), and then outputs the pair of the new instruction code and identification number obtained by the above rewriting process (Step S7).

On the other hand, when the following lower two bits do not equal to the terminal code “00”, the instruction rewriting unit 3 outputs the instruction code and the identification number (Step S7). Thus, the instruction rewriting unit 3 inputs plural groups of instruction codes and plural identification numbers, and outputs a group of the instruction code and the identification number. The plural groups of the instruction codes and the identification numbers received by the instruction rewriting unit 3 are processed based on the procedures shown in FIG. 5. The instruction rewriting unit 3 outputs one group of the instruction code and the identification number. When the group information of more than two groups are different, the process enters an exceptional treatment. In this case, one of groups is selected.

The switch section 15 determines one of the data driven computers 11, 12, and 13 based on the lower two bits in the received instruction code.

Next, a description will be given of the operation of a software that is executed by the data driven computer system by using the following equation (1).

a1*z1+a2*x2+a3*x3 (1),

where the reference character “*” indicates multiplication.

First, the microprocessor 14 outputs a series of data groups (each data group consists of data, instruction codes, and identification numbers) to the switch section 15. The series of data groups is compiled in advance by a compiler (not shown) or by a program executed by the microprocessor 14 based on the following procedure.

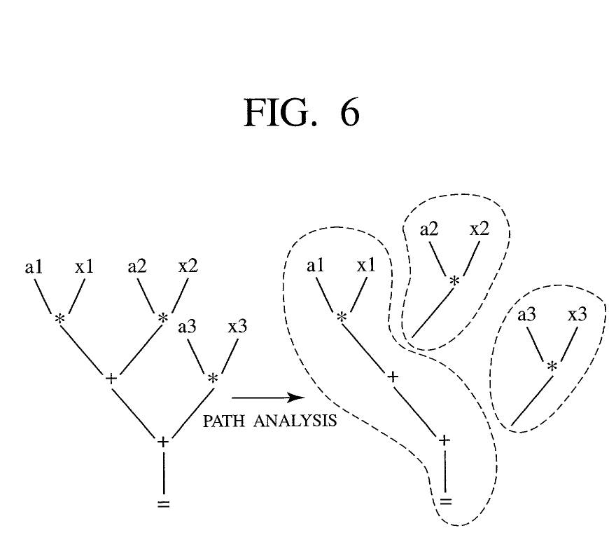

FIG. 6 shows the calculation tree expressing the equation (1). In FIG. 6, the path analysis is performed based on arithmetic signs in the calculation tree in order to extract all paths. The equation (1) has the following three paths.

| | | |
|---|---|---|
| ((a1, x1), | (*, +, +, =)) | . . . path 1, |
| ((a2, x2), | (*)) | . . . path 2, and |
| ((a3, x3), | (*)) | . . . path 3, |

where, the first field is the list of arguments, and the second field includes arithmetic codes which are executed from the right side to the left side in order.

Next, when each identification number is given into each path, the following lists can be obtained.

| | | |
|---|---|---|
| ((a1, x1), (*, +, +, =), | (1)) | . . . path 1, |
| ((a2, x2), (*), | (2)) | . . . path 2, and |
| ((a3, x3), (*), | (3)) | . . . path 3, |

where, the third field is the identification number of the path.

Next, it is checked which path is calculated together with the path having the terminal code to be currently processed. The operation is checked for all paths. As the result, the following relationships of the paths can be obtained.

| | | |
|---|---|---|
| ((a1, x1), (+, +, +, =), | (1, 0)) | . . . path 1, |
| ((a2, x2), (*), | (2, 1)) | . . . path 2, and |
| ((a3, x3), (*), | (3, 1)) | . . . path 3, |

where, the identification number “0” indicates a special meaning that this path outputs the final calculation result.

The second relationship, namely the path 2″ ((a2, x2), (*), (2, 1))″ described above, indicates that the result of “a2*x2” is calculated with the calculation result of path 1. As apparently understood, the calculation scheduling in the calculation that satisfies the associative relationship is automatically performed. That is, the path whose calculation result is obtained faster has a high priority in following calculation. Finally, the lists of the paths described above are converted into formats that can be executed by the computer. This conversion divides each path into two parts (two lines). As described above, the conversion generates the following streams, each stream has a series of data, instruction, and identification number.

| | | |
|---|---|---|
| ((a1, x1), | (*, +, +, =), | (1, 0))), |
| ((x1), | (*), | (1)), |
| ((a2, x2), | (*), | (2, 1)), |
| ((x2), | (*), | (2)), |
| ((a3, x3), | (*), | (3, 1)), and |
| ((x3), | (*), | (3) ). |

Although the series of the above instruction/data do not be coded, these data stream are supplied into the computer. When the arithmetic symbols are coded, the following data1 to data 6 can be obtained.

In the following data1 to data6, for example, both the instruction code “(00_{—}11_{—}01_{—}01_{—}10)” and the identification number “(00_{—}01)” in data1 are processed from the right to left in order.

| | | |
|---|---|---|
| ((value of a1), | (00_11_01_01_10), (00_01) | . . . data1, |
| ((value of x1), | (00_00_00_00_10), (00_01) | . . . data2, |
| ((value of a2), | (00_00_00_01_10), (01_10) | . . . data3, |
| ((value of x1), | (00_00_00_00_10), (00_10) | . . . data4, |
| ((value of a3), | (00_00_00_01_10), (01_11) | . . . data5, and |
| ((value of x3), | (00_00_00_00_10), (00_11) | . . . data6. |

When the series of the instruction/data described above are referred with data1, data2, data3, data4, data5, and data6, the following TABLE1 shows the processes of these data. In this case, one clock is necessary to pass the switch section 15, one clock is necessary to read data from and to store data into each of the CAM 114 and the CAM 124, and one clock is necessary to take a latency of each of the arithmetic units 111, 121, and 131, and the instruction rewriting units 115, 125, and 135 that can be executed with the arithmetic units 111, 121, and 131 in parallel.

TABLE 1

| C | | | Arithmetic | | Arithmetic | Arithmetic |
|---|---|---|---|---|---|---|
| L | | CAM 114 | Unit 111 | CAM 124 | Unit 121 | Unit 131 |
| O | | in | in | in | in | in |
| C | Switch | Computer | Computer | Computer | Computer | Computer |
| K | 15 | 11 | 11 | 12 | 12 | 13 |
| 1 | 1 | | | | | |
| 2 | 2 | | | 1 | | |
| 3 | 3 | | | 2 | 1 | |
| 4 | 4 | | | 3 | 1 * 2 −> 1 | |
| 5 | 5,1 | | | 4 | 3 | |
| 6 | 6 | 1 | | 5 | 3 * 4 −> 3 | |
| 7 | 3 | | 1 | 6 | 5 | |
| 8 | | 3 | 1 + 3 −> 1 | | 5 * 6 −> 5 | |
| 9 | 5 | | | | | |
| 10 | 1 | 5 | 5 | | | |
| 11 | | 1 | | | | |
| 12 | | | 1 + 5 −> 1 | | | |
| 13 | 1 | | | | | |
| 14 | | | | | | 1 |

As shown in TABLE1, at clock 1, the microprocessor 14 transfers the data1 to the switch section 15.

At clock 2, the data1 is inputted to the computer 12 because the instruction code “10” in the data1 indicates the multiplication. In addition, the microprocessor 14 outputs the data2 to the switch section 15.

At clock3, the data1 enters the operand wait in the computer 12. Because the instruction code “10” of the data2 is the multiplication, the instruction code “10” of the data2 is inputted to the computer 12. The microprocessor 14 supplies the data 3 to the switch section 15.

At clock 4, the arithmetic unit 121 performs the multiplication between the data1 and the data2 and writes the multiplication result into the data1. The arithmetic unit 121 outputs the data1 into the instruction rewriting unit 125. The instruction rewriting unit 125 in the computer 12 rewrites the instruction code of the data1 as follows:

((a1*x1), (00_{—}11_{—}01_{—}01), (00_{—}01)) . . . data1.

The instruction rewriting unit 125 eliminates the data2. Because the instruction code “10” of the data3 is the multiplication, the data3 is transferred to the computer 12. The microprocessor 14 outputs the data4 to the switch section 15.

At clock 5, the data1 is inputted into the switch section 15. The data3 enters the operand wait in the computer 12. Because the instruction code “10” of the data4 is the multiplication, the data4 is transferred to the computer 12. The microprocessor 14 outputs the data5 to the switch section 15.

At clock 6, because the instruction code “01” of the data1 is the addition, the data1 is transferred to the computer 11. The arithmetic unit 121 performs the multiplication of the data3 and the data4 and writes the multiplication result into the data3, and outputs the data3 to the instruction rewriting unit 125. The instruction rewriting unit 125 receives and then rewrites the instruction code of the data3 as follows:

((a2*x2), (00_{—}00_{—}00_{—}01), (01)) . . . data3.

The instruction rewriting unit 125 in the computer 12 eliminates the data4. Because the instruction code “10” of the data5 is the multiplication, the data5 is transferred to the computer 12. The microprocessor 14 outputs the data6 to the switch section 15.

At clock 7, the data1 enters the operand wait in the computer 11. The data3 is transferred to the switch section 15. The data5 enters the operand wait in the computer 12. Because the instruction code “10” of the data6 is the multiplication, the instruction code “10” of the data6 is inputted to the computer 12.

At clock 8, the data1 enters the operand wait in the computer 11. Because the instruction code “01” of the data3 is the addition, the instruction code “01” of the data3 is inputted to the computer 11. The arithmetic unit 121 performs the multiplication of the data5 and the data6, and writes the multiplication result into the data5, and transfers the data5 into the instruction rewriting unit 125. The instruction rewriting unit 125 rewrites the instruction code of the data5 as follows:

((a3*x3), (00_{—}00_{—}00_{—}01), (01)) . . . data5.

The instruction rewriting unit 125 eliminates the data6.

At clock 9, the arithmetic unit 121 performs the multiplication of the data1 and the data3, and writes the multiplication result into the data1, and transfers the data1 into the instruction rewriting unit 125. The instruction rewriting unit 125 rewrites the instruction code of the data as follows:

(((a1*x1)+(a2*x2)), (00_{—}11_{—}01), (00_{—}01)) . . . data1.

The instruction rewriting unit 125 in the computer 12 eliminates the data3. The data5 is transferred to the switch section 15.

At clock 10, the data1 is transferred to the switch section 15. Because the instruction code “01” of the data5 is the addition, the instruction code “01” of the data5 is inputted to the computer 11.

At clock 11, because the instruction code “01” of the data1 is the addition, the instruction code “01” of the data1 is inputted to the computer 11. The data5 enters the operand wait in the computer 11.

At clock 12, the arithmetic unit 111 performs the addition of the data1 and the data5 and writes the addition result into the data1, and outputs the data1 to the instruction rewriting unit 115. The instruction rewriting unit 115 receives and then rewrites the instruction code of the data1 as follows:

((((a1*x1)+(a2*x2))+(a3*x3)), (00_{—}11), (00)) . . . data1.

The instruction rewriting unit 115 in the computer 11 eliminates the data5.

At clock 13, because the instruction code “11” of the data1 is the substitution, the instruction code “11” of the data1 is inputted to the computer 13.

At clock 14, the arithmetic unit 131 in the computer 13 performs the substitution of the data1, and then the instruction rewriting unit 134 in the computer 13 eliminates the data1. The arithmetic operation of the equation (1) is thereby completed.

As apparently shown by the operations in TABLE 1, it is possible to perform the instruction issues and the data dependence operations by the data driven computer system with a simple configuration.

Although the preferred embodiment described above does not necessarily show a remarkable effect of the present invention because the example of the equation is relatively short, for example, because the arithmetic operation satisfying the associative relationship can be automatically scheduled when a long and complicated equation for image processing is executed, it is possible to increase the efficiency of the use of the arithmetic units.

Any conventional scalar processors cannot perform this dynamical optimization for the execution efficiency. Although one equation is executed in the above-described preferred embodiment of the present invention, it is apparently that the data driven computer system of the present invention can perform a plurality of equations in parallel. In this case, the execution efficiency of the arithmetic units can be further increased.

Furthermore, although the data driven computer system described above has only one computer for each of the addition and the multiplication, it is possible to easily increase the execution performance when this computer system has a plurality of the computers of the same kind.

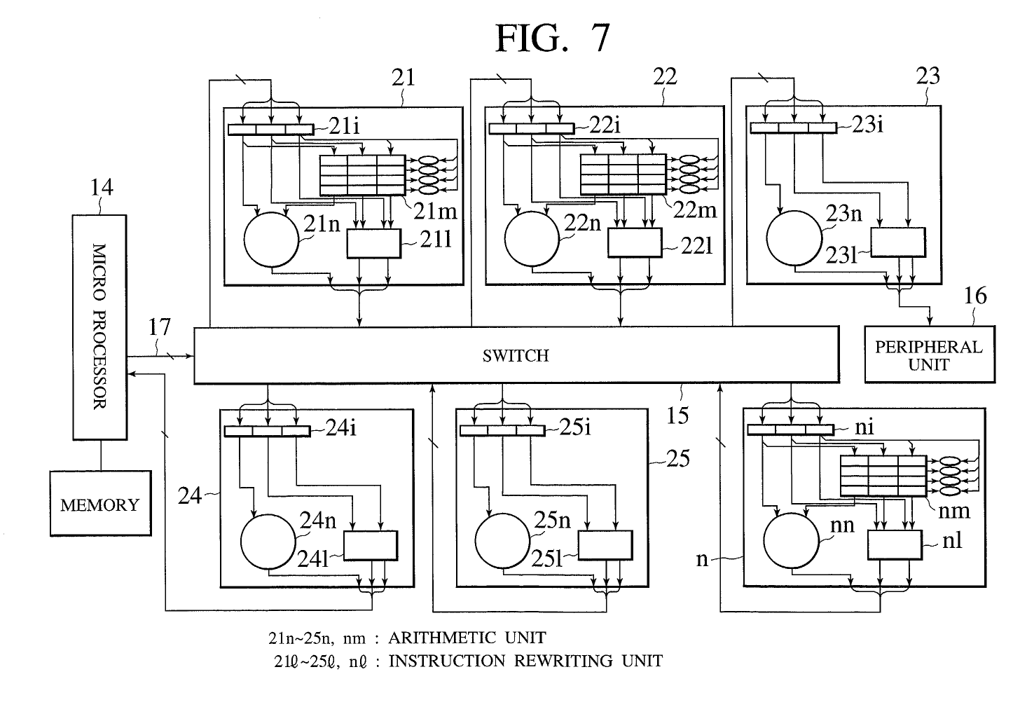

FIG. 7 is a block diagram showing a configuration of another data driven computer system including the data driven computer according to another preferred embodiment of the present invention. As shown in FIG. 7, it is possible for the data driven computer system to perform various kinds of arithmetic operations by incorporating a plurality of and many kinds of data driven computers. The data driven computer system shown in FIG. 7 comprises the data driven computers 21, 22, 23, 24, 25, . . . , and 2n, the microprocessor 14, the switch section 15, the peripheral unit 16. The memory connected to the microcomputer 16 stores a string of instruction/data as the results of a compiler (not shown) or a string of instruction/data obtained by executing a program by the microprocessor 14, like the data driven computer system shown in FIG. 4.

Each of the data driven computers 21, 22, 23, 24, 25, . . . , n corresponds to each data driven computer shown in FIGS. 1, 2, and 3. Each of the input instruction/data storing units 21i, 22i, 23i, 24i, 25i, and ni in the data driven computers 21, 22, 23,24,25, . . . , n corresponds to the input instruction/data storing unit 4 in each of the data driven computers shown in FIGS. 1, 2, and 3. Similarly, each of the arithmetic units 21n, 22n, 23n, 24n, 25n, and nn in the data driven computers 21, 22, 23, 24, 25, . . . , n corresponds to the arithmetic unit 1 in each of the data driven computers shown in FIGS. 1, 2, and 3, and each of the instruction rewriting units 211, 221, 231, 241, 251, and nl in the data driven computers 21, 22, 23, 24, 25, . . . , n corresponds to the instruction rewriting unit 4 in each of the data driven computers shown in FIGS. 1, 2, and 3. In addition, each of the reference characters 21m, 22m, and 23m denotes a CAM that corresponds to the CAM 2 shown in each of FIGS. 1, 2, and 3.

The conventional Neumann type super scalar computers require a controller having a complicated configuration for the pipeline control that is necessary to execute the out of order processing for checking data hazard, resource hazard, and the like. On the contrary, the data driven computer system according to the preferred embodiment of the present invention comprise a plurality of the data driven computer each having the CAM 2 and the instruction rewriting unit 3, so that it is possible to perform the dynamical scheduling of the instruction issues without any control circuit of the complicated circuit configuration and to increase the degree of the parallel processing for calculations.

In addition, because the data driven computer and the system thereof according to the present invention have a simple hardware configuration, it is possible to perform the design and verification easily, and to perform the software with a high speed. Further, because the computer and the system thereof according to the present invention has no any branch instruction, it is possible to increase the efficiency in use without any occurring any branch penalty.

Moreover, as a new feature of the present invention that is not involved in the conventional computer and system, as also described above, because the arithmetic operation satisfying the associative relationship can be automatically scheduled when a long and complicated equation is executed, it is possible to increase the efficiency of the use of the arithmetic units.

Furthermore, because both the CAM 2 and the instruction rewriting unit 3 are added into the arithmetic unit 1 in each data driven computer, the instruction issues can be performed in distributed processing. The degree of the parallel processing is automatically changed according to the number of the arithmetic units. It is thereby possible to easily change the hardware configuration of the data driven computer and system of the present invention.

As set forth in detail, according to the present invention, it is possible to easily design and verify the data driven computer and the system thereof with a simple configuration, to increase the degree of the parallel processing for calculations, and to execute the instruction at a high speed. In addition, because it is possible to perform the scheduling of instructions dynamically, the efficiency of the use of the arithmetic units in the system can be increased.

While the above provides a full and complete disclosure of the preferred embodiments of the present invention, various modifications, alternate constructions and equivalents may be employed without departing from the scope of the invention. Therefore the above description and illustration should not be construed as limiting the scope of the invention, which is defined by the appended claims.

What is claimed is:

1. A data driven computer comprising:
a storing unit for inputting and temporarily storing an information group made up of an instruction code to determine operation of the computer, target data, including data to be used in arithmetic operation, as a target in the arithmetic operation indicated by the instruction code, and an identification code to identify data to be calculated with the target data;
a content address memory (CAM), connected with the storing unit, for storing one or more the information groups in which the information group is searched by using the identification number as a searching key, and the information group is red and outputted when the information group designated by the searching key is stored, and the information group is stored into the CAM when the information group designated by the searching key is not stored in the CAM;
an arithmetic unit for inputting the instruction code stored in the storing unit or in the CAM, the data stored in the storing unit, and the data stored in the CAM, and then for performing arithmetic operation of these data; and
an instruction rewriting unit for inputting the instruction codes and the identification codes transferred from both the storing unit and the CAM, for calculating an information group to be executed in a following processing, in parallel to the arithmetic operation of the arithmetic unit, and for rewriting the inputted information groups into the calculated information group.

2. A data driven computer comprising:
a storing unit for inputting and temporarily storing an information group made up of an instruction code to determine operation of the computer, target data, including data to be used in arithmetic operation, as a target in the arithmetic operation indicated by the instruction code, and an identification code to identify data to be calculated with the target data;
an arithmetic unit for inputting the instruction code and data in the information group stored in the storing unit, and then performing arithmetic operation of the data; and
an instruction rewriting unit for inputting the instruction code and the identification code transferred from the storing unit, for calculating an information group to be executed in a following processing, in parallel to the arithmetic operation of the arithmetic unit, and for rewriting the inputted information group into the calculated information group.

3. A data driven computer system comprising:
a plurality of the data driven computers as claimed in claim 1;
a switch section connected to the data driven computers for inputting the information group transferred from the data driven computers, and for selecting the data driven computer based on the instruction code in the information group transferred from the data driven computers, and for outputting the information group to the selected data driven computer.

4. A data driven computer system comprising:
a plurality of the data driven computers as claimed in claim 2;
a switch section connected to the data driven computers for inputting the information group transferred from the data driven computers, and for selecting the data driven computer based on the instruction code in the information group transferred from the data driven computers, and for outputting the information group to the selected data driven computer.

5. A data driven computer system comprising:
a plurality of data driven computers which include at lease one data driven computer as claimed in claim 1 and at least one data driven computer as claimed in claim 2; and
a switch section connected to the data driven computers for inputting the information group transferred from the data driven computers, and for selecting the data driven computer based on the instruction code in the information group transferred from the data driven computers, and for outputting the information group to the selected data driven computer.

6. A data driven computer system according to claim 3, wherein the switching section is connected to outer computer system, and connected to a peripheral device through the data driven computer, and the switching section inputs the information group from and outputs the information group to the outer computer system, and outputs the information group to the peripheral device.

7. A data driven computer system according to claim 4, wherein the switching section is connected to outer computer system, and connected to a peripheral device through the data driven computer, and the switching section inputs the information group from and outputs the information group to the outer computer system, and outputs the information group to the peripheral device.

8. A data driven computer system according to claim 5, wherein the switching section is connected to outer computer system, and connected to a peripheral device through the data driven computer, and the switching section inputs the information group from and outputs the information group to the outer computer system, and outputs the information group to the peripheral device.
